(19) United States
(12) Patent Application Publication
(10) Pub. No.: US 2026/0202727 A1
(43) Pub. Date: Jul. 16, 2026

(54) PROJECTION DISPLAY DEVICE

(71) Applicant: JVCKENWOOD Corporation, Yokohama-shi (JP)

(72) Inventor: Toshiro Kono, Yokohama-shi (JP)

(21) Appl. No.: 19/567,412

(22) Filed: Mar. 16, 2026

Related U.S. Application Data
(63) Continuation of application No. PCT/JP2024/020667, filed on Jun. 6, 2024.

(30) Foreign Application Priority Data
Sep. 21, 2023 (JP) 2023-156264

(51) Int. Cl. G03B 21/20; G03B 21/00

(52) U.S. Cl. CPC G03B 21/2053; G03B 21/006; G03B 21/2013; G03B 21/2033

(57) ABSTRACT

A projection display device according to an embodiment in which a light source emits a laser light to be used in projection of an image and in which a hide function is provided that temporarily hides the projection of the image by stopping the emission of light from the light source. The projection display device includes: a light source temperature sensor that detects the temperature of the light source; a light source heating unit that heats the light source; a control unit that controls the operation of at least the light source and the light source heating unit; and a switch that is used to instruct implementation or deactivation of the hide function. When implementation of the hide function is instructed using the switch, the control unit stops the emission of light from the light source, obtains the temperature detected by the light source temperature sensor, and controls the light source heating unit to maintain the light source at the obtained temperature.

### CROSS-REFERENCE TO RELATED APPLICATIONS

This application is a Continuation of PCT International Application No. PCT/JP2024/020667 filed on Jun. 6, 2024 which claims the benefit of priority from Japanese Patent Application No. 2023-156264, filed on Sep. 21, 2023, the entire contents of both of which are incorporated herein by reference.

### BACKGROUND OF THE INVENTION

### 1. Field of the Invention

The application concerned is related to a projection display device that is equipped with a function for temporarily hiding the projected images by switching off the light source.

### 2. Description of the Related Art

Generally, a projection display device is known in which reflective liquid crystal display elements are used (for example, refer to Japanese Patent Application Laid-open No. 2005-227485). In a projection display device of that type, for example, a fluorescent substance is irradiated with a blue laser light emitted from a blue laser light source and a white light is generated; and the white light is separated into a red light, a blue light, and a green light. Then, images in which the red light, the blue light, and the green light are modulated using reflective liquid crystal display elements are projected in an enlarged manner on a screen.

Meanwhile, a projection display device of the abovementioned type is equipped with a hide function for temporarily hiding the projected images. In that configuration, when the light source that emits a laser light is stopped (switched off), a pitch-black color can be created on the projection surface. That technique proves to be highly effective, for example, in showing the night sky in a planetarium or in performing blending in which a plurality of images is superimposed and projected.

In a projection display device, in order to maintain the imaging quality at an excellent level, it is important to maintain the temperature of the liquid crystal display elements as well as the light source within a specified range. In the conventional configuration, at the time of implementing the hide function, when the light source is temporarily switched off, there occurs a drop in the temperature of that light source. For that reason, when the hide function is deactivated, till the time when the light source is heated to a predetermined temperature, the output of that light source becomes unstable. For that reason, the issue of not being able to promptly project excellent images is likely to arise.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A projection display device in which a light source emits a laser light to be used in projection of an image and in which a hide function is provided that temporarily hides projection of the image by stopping emission of light from the light source, the projection display device according to the present disclosure comprising: a light source temperature sensor that detects temperature of the light source; a light source heating unit that heats the light source; a control unit that controls operation of at least the light source and the light source heating unit; and a switch that is used to instruct implementation or deactivation of the hide function, wherein when implementation of the hide function is instructed using the switch, the control unit stops emission of light from the light source, obtains temperature detected by the light source temperature sensor, and controls the light source heating unit to maintain the light source at the obtained temperature.

A projection display device in which a light source emits a laser light to be used in projection of an image and in which a hide function is provided that temporarily hides projection of the image by stopping emission of light from the light source, the projection display device according to the present disclosure comprising: a light source heating unit that heats the light source; an information obtaining unit that obtains relationship between output of the light source and temperature of the light source, and obtains relationship between output of the light source heating unit and temperature of the light source; a control unit that controls operation of at least the light source and the light source heating unit; and a switch that is used to instruct implementation or deactivation of the hide function, wherein when implementation of the hide function is instructed using the switch, the control unit stops emission of light from the light source; estimates, based on the information obtained by the information obtaining unit, temperature of the light source corresponding to output of the light source; and controls the light source heating unit to perform at output corresponding to the estimated temperature.

### BRIEF DESCRIPTION OF THE DRAWINGS

FIG. 1 is a schematic diagram illustrating a projection display device according to a first embodiment;

FIG. 2 is a schematic block diagram of a control unit according to the first embodiment;

FIG. 3 is a flowchart for explaining the sequence of operations performed by the control unit according to the first embodiment;

FIG. 4 is a schematic diagram illustrating a projection display device according to the second embodiment;

FIG. 5 is a schematic block diagram of a control unit according to the second embodiment; and

FIG. 6 is a flowchart for explaining the sequence of operations performed by the control unit according to the second embodiment.

### DETAILED DESCRIPTION OF THE PREFERRED EMBODIMENTS

Exemplary embodiments of the application concerned are described in detail with reference to the accompanying drawings. However, the application concerned is not limited by the embodiments described below.

### First Embodiment

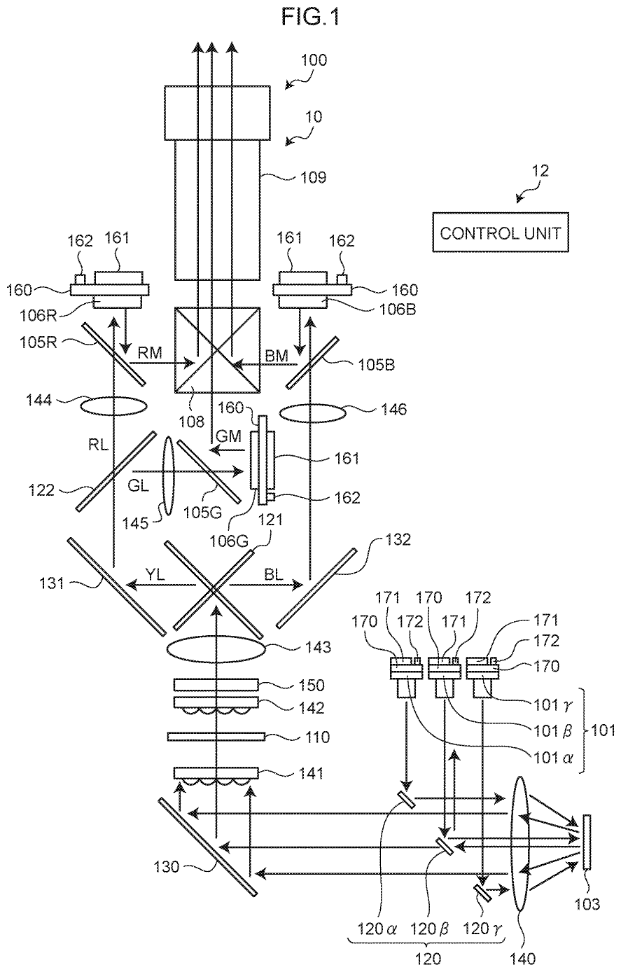

FIG. 1 is a schematic diagram illustrating a projection display device according to a first embodiment. The projection display device is a display device in which a fluorescent substance is irradiated with a visible light (for example, a blue laser light) and a white light is generated; the white light is separated into a red light, a blue light, and a green light; and images formed by modulating and synthesizing the red light, the blue light, and the green light are displayed. As illustrated in FIG. 1, a projection display device 100 includes a display mechanism 10 and a control unit 12. The display mechanism 10 includes a light source 101; a fluorescent substance 103; polarizing plates 105R, 105G, and 105B; a first display element 106R; a second display element 106G; a third display element 106B; a dichroic prism 108; a projection lens 109; a quarter-wavelength film 110; dichroic mirrors 120 to 122; reflecting mirrors 130 to 132; lenses 140 to 146; and a polarization converter 150. The first display element 106R, the second display element 106G, and the third display element 106B are, for example, reflective liquid crystal display elements that are configured by sandwiching a liquid crystal display between a silicon substrate and a glass substrate and that are disposed in a corresponding manner to the colors as explained later.

The dichroic mirrors 120 to 122 have the property of separating the incident light by means of reflection and transmission, with the separating wavelengths serving as the separation boundaries. The dichroic mirrors 120 to 123 can be manufactured, for example, by forming a dielectric multi-layer film in a predetermined area of a transparent material such as a glass plate or a prism. Herein, the optical characteristics can be set according to the material and the thickness of the dielectric body constituting the dielectric multi-layer film.

The light source 101 emits an illumination light representing the light having the wavelength band of the visible light. In the first embodiment, the light source 101 is a blue laser light source configured with blue laser elements and emits, for example, a blue illumination light having the wavelength band equal to or greater than 450 (nm) and equal to or smaller than 495 (nm).

In the first embodiment, the light source 101 includes a group of three (a plurality of) blue laser light sources, namely, a first blue laser light source 101α, a second blue laser light source 101β, and a third blue laser light source 101γ having different oscillation wavelengths. The first blue laser light source 101α, the second blue laser light source 101β, and the third blue laser light source 101γ have the oscillation wavelengths set to be different from each other at least by 10 (nm) or more. More particularly, the first blue laser light source 101α is set to have the oscillation wavelength of 445 (nm), the second blue laser light source 101β set to have the oscillation wavelength of 455 (nm), and the third blue laser light source 101γ is set to have the oscillation wavelength of 465 (nm).

Generally, when a blue laser light source having a short wavelength is used as the single-wavelength light source, due to the unevenness in the thickness (cell thickness) of the liquid crystal display elements, sometimes bridges (interference fringes) are formed at which there occurs division into bright regions and dark regions, and the bridges get superimposed on the displayed image. For that reason, the thickness of the liquid crystal display elements needs to be tightly controlled. In contrast, in the first embodiment, as explained above, the configuration includes a group of three light sources, namely, the first blue laser light source 101α, the second blue laser light source 101β, and the third blue laser light source 101γ having oscillation wavelengths different from each other at least by 10 (nm) or more. Hence, due to the difference in the oscillation wavelengths, the intervals between the bridges and the positions of the valleys undergo changes, and particularly there is reduction in the bridges in blue images. As a result, it becomes possible to ease the standard for controlling the thickness of the liquid crystal display elements.

The oscillation wavelengths of the first blue laser light source 101α to the third blue laser light source 101γ are only exemplary, and can be appropriately varied as long as they are within the wavelength band of the blue color. Moreover, the difference values between the oscillation wavelengths among the blue laser light sources can be appropriately varied within, for example, the range between and including 10 (nm) and 20 (nm). Furthermore, as long as a plurality of blue laser light sources is present as a group, the number of blue laser light sources is not limited to three.

The blue illumination light emitted by the light source 101 fall on the dichroic mirror 120. The dichroic mirrors 120 have the property of reflecting the blue illumination light and letting the yellow illumination light pass through. In the first embodiment, the dichroic mirror 120 includes dichroic mirrors 120α, 120β, and 120γ placed corresponding to the first blue laser light source 101α, the second blue laser light source 101β, and the third blue laser light source 101γ, respectively.

The blue illumination lights emitted by the first blue laser light source 101α to the third blue laser light source 101γ get reflected from the dichroic mirrors 120α to 120γ, respectively; the reflected lights are condensed by the lens 140; and the condensed light falls on the fluorescent substance 103. The fluorescent substance 103 has a fluorescent layer and a reflecting surface. The fluorescent layer generates a yellow illumination light that includes the red band component and the green band component having the intensity corresponding to the energy intensity of the blue illumination lights emitted by the first blue laser light source 101α to the third blue laser light source 101. The reflecting surface reflects the blue illumination light, which has passed through the fluorescent layer, and the yellow illumination light, which is generated by the fluorescent layer.

The dichroic mirrors 120α, 120β, and 120γ are formed to have smaller dimensions than the beam width of the reflected light (the diffused light) coming from the fluorescent substance 103. Moreover, the dichroic mirrors 120α, 120β, and 120γ are oriented in such a way that the direction of polarization of the laser light with respect to the dichroic mirrors 120α, 120β, and 120γ results in the s-polarized light. For that reason, the dichroic mirrors 120α, 120β, and 120γ have the property that, of the blue illumination light falling thereon, the s-polarized light is reflected and the p-polarized light is passed through; and that the yellow illumination light is passed through regardless of the direction of polarization.

Thus, the yellow illumination light (the fluorescence), which is wavelength-excited by the fluorescent substance and which includes the red component and the green component, gets mixed with the non-fluorescent blue illumination light, and the resultant light again falls on the dichroic mirrors 120α, 120β, and 120γ. The yellow illumination light representing the fluorescence and including the red component and the green component passes through the dichroic mirrors 120α, 120β, and 120γ and travels ahead in entirety. On the other hand, when getting reflected (diffused) from the fluorescent substance 103, the blue illumination light becomes a random polarized light having a mix of a plurality of polarized lights. For that reason, of the components of the blue illumination light falling on the dichroic mirrors 120α, 120β, and 120γ, the p-polarized light passes through the dichroic mirrors 120α, 120β, and 120γ and travels ahead, but the s-polarized light gets reflected from the dichroic mirrors 120α, 120β, and 120γ and returns to the first blue laser light source 101α to the third blue laser light source 101γ.

The blue illumination light and the yellow illumination light, which has passed through the dichroic mirrors 120α, 120β, and 120γ, get reflected from the reflecting mirror 130 and falls on the lens 141. The lenses 141 and 142 are, for example, fly-eye lenses. In between the lenses 141 and 142, the quarter-wavelength film 110 is disposed. After having reflected from the reflecting mirror 130, the blue illumination light and the yellow illumination light have their illuminance distribution equalized due to the lens 141, the quarter-wavelength film 110, and the lens 142, before falling on the polarization converter 150. The polarization converter 150 includes, for example, a polarizing beam splitter and a wave plate. The polarizing beam splitter reflects one of the s-polarized light and the p-polarized light, and lets the other light pass through. In the example illustrated in FIG. 1, the polarizing beam splitter reflects the s-polarized light and lets the p-polarized light pass through. The wave plate either converts the s-polarized light into the p-polarized light, or vice versa. In the example illustrated in FIG. 1, the wave plate converts the s-polarized light into the p-polarized light. As a result of having the polarization converter 150, all illumination lights are matched to the p-polarized light.

The illumination lights, which have been matched to the p-polarized light due to the polarization converter 150, fall on the dichroic mirror 121 via the lens 143. The lens 143 is, for example, a condenser lens.

The dichroic mirror 121 separates the incident light into a blue illumination light BL and a yellow illumination light YL. The yellow illumination light YL that is separated by the dichroic mirror 121 gets reflected from the reflecting mirror 131 and falls on the dichroic mirror 122.

The dichroic mirror 122 treats the intermediate wavelength between the red spectral region and the green spectral region as the separation boundary; and separates the incident yellow illumination light YL into a red illumination light RL, which includes the red band component, and a green illumination light, which includes the green band component. More particularly, of the incident yellow illumination light YL, the dichroic mirror 122 reflects the green band component and outputs the green illumination light GL, and lets the red band component to pass through and outputs the red illumination light RL. The red illumination light RL represents the light having, for example, the wavelength band equal to or greater than 620 (nm) and equal to or smaller than 750 (nm); and the green illumination light GL represents the light having, for example, the wavelength band equal to or greater than 495 (nm) and equal to or smaller than 570 (nm).

The red illumination light RL that is separated by the dichroic mirror 122 falls on the polarizing plate 105R via the lens 144. The green illumination light GL that is separated by the dichroic mirror 122 falls on the polarizing plate 105G via the lens 145. The blue illumination light BL that is separated by the dichroic mirror 121 gets reflected from the reflecting mirror 132 and falls on the polarizing plate 105B via the lens 146.

The polarizing plates 105R, 105G, and 105B have the property of reflecting either one of the s-polarized light or the p-polarized light, and letting the other polarized light pass through. In the example illustrated in FIG. 1, the polarizing plates 105R, 105G, and 105B reflect the s-polarized light, and let the p-polarized light pass through. The polarizing plates 105R, 105G, and 105B are also referred to as reflecting polarizing plates. For example, the polarizing plates 105R, 105G, and 105B are wire grid polarizing plates.

The red illumination light RL, which represents the p-polarized light, passes through the polarizing plate 105R and falls on the first display element 106R. The green illumination light GL, which represents the p-polarized light, passes through the polarizing plate 105G and falls on the second display element 106G. The blue illumination light BL, which represents the p-polarized light, passes through the polarizing plate 105B and falls on the third display element 106B.

The first display element 106R modulates the red illumination light RL, which represents the p-polarized light, based on the image data of the red component; and generates a red image light RM that represents the s-polarized light. The second display element 106G modulates the green illumination light GL, which represents the p-polarized light, based on the image data of the green component; and generates a green image light GM that represents the s-polarized light. The third display element 106B modulates the blue illumination light BL, which represents the p-polarized light, based on the image data of the blue component; and generates a blue image light BM that represents the s-polarized light. That is, the first display element 106R functions as a red image optical modulation element, the second display element 106G functions as a green image optical modulation element, and the third display element 106B functions as a blue image optical modulation element.

The red image light RM, which is generated by the first display element 106R and which represents the s-polarized light, reflects from the polarizing plate 105R and falls on the dichroic prism 108. The green image light RM, which is generated by the second display element 106G and which represents the s-polarized light, reflects from the polarizing plate 105G and falls on the dichroic prism 108. The blue image light RB, which is generated by the third display element 106B and which represents the s-polarized light, reflects from the polarizing plate 105B and falls on the dichroic prism 108.

The dichroic prism 108 reflects the red image light RM and the blue image light BM; lets the green image light GM pass through; and outputs the image lights onto the projection lens 109.

The red image light RM, the green image light GM, and the blue image light BM are projected onto a screen (not illustrated) via the projection lens 109. Due to the red image light RM, the green image light GM, and the blue image light BM; a visible light image gets displayed.

The projection display device 100 according to the first embodiment is equipped with the hide function (the image mute function) for temporarily hiding the projected images or for displaying a completely black screen. The hide function of this type is neither limited to stopping the operation of the display elements 106R, 106G, and 106B corresponding to the red, green, and blue colors nor limited to displaying a completely black screen. That is, when a laser diode (LD) or a light-emitting diode (LED) capable of instant illumination and instant blackout is used as the light source 101, the hide function stops (switches off) the light emission from the light source 101 and creates a pitch-black color on the projection surface (for example, the screen). That technique proves to be highly effective, for example, in showing the night sky in a planetarium or in performing blending in which a plurality of images is superimposed and projected. The implementation and the deactivation of the hide function can be instructed by operating, for example, a switch 165 (explained later) that is disposed in the main body of the projection display device 100.

Moreover, the projection display device 100 according to the first embodiment allows the user to select a normal operation mode and a hide mode as the operation modes. While the hide mode is selected, when implementation of the hide function is instructed, the projection display device 100 either stops the operation of the display elements 106R, 106G, and 106B corresponding to the red, green, and blue colors or displays a completely black screen, as well as stops (switches off) the light emission from the light source 101. As a result, the projected images are temporarily hidden until deactivation of the hide function is instructed. Moreover, while the normal operation mode is selected (while the hide mode is not selected), when implementation of the hide function is instructed, the projection display device 100 continues with the light emission from the light source 101 but either stops the operation of the display elements 106R, 106G, and 106B corresponding to the red, green, and blue colors or displays a completely black screen. As a result, the projected images are temporarily hidden until deactivation of the hide function is instructed. In the first embodiment, the explanation is given about the configuration in which the hide mode is selected, that is, the explanation is given about the configuration in which the light emission from the light source 101 is stopped (switched off) when implementation of the hide function is instructed.

As explained above, when the hide mode is selected and when implementation of the hide mode is instructed (hereinafter, simply referred to as when implementation of the hide mode instructed), the projection display device 100 either stops the operation of the display elements 106R, 106G, and 106B corresponding to the red, green, and blue colors or displays a completely black screen, as well as stops (switches off) the light emission from the light source 101. As a result, the projected images are temporarily hidden. In that case, as a result of temporarily stopping the display elements 106R, 106G, and 106B and the light source 101, there occurs a drop in the temperature of the display elements 106R, 106G, and 106B and the light source 101. For that reason, even when the hide function is deactivated, till the time when the display elements 106R, 106G, and 106B and the light source 101 are heated to the predetermined temperature that was attained before the stoppage, the output of the display elements 106R, 106G, and 106B and the light source 101 becomes unstable. As a result, the issue of not being able to promptly project excellent images is likely to arise.

In the first embodiment, as illustrated in FIG. 1, on the backside of each of the display elements 106R, 106G, and 106B corresponding to the red, green, and blue colors (i.e., on that face of the display elements 106R, 106G, and 106B which is on the opposite side to the side on which the corresponding illumination light falls), the display mechanism 10 includes an element heater (an element heating unit) 161 disposed through a heat sink 160 and includes an element temperature sensor 162 disposed on the heat sink 160. The heat sinks 160 are plate members made of a metal such as aluminum having high thermal conductivity and having a constant thickness. Each heat sink 160 is formed to be greater in size than the backside of the corresponding display element, and the entire backside of the display element remains in contact with the heat sink 160.

The element heaters 161 heat the display elements 106R, 106G, and 106B via the corresponding heat sinks 160. As the element heaters 161, for example, plate-like ceramic heaters can be used. As a result of having the element heaters 161 disposed in the heat sinks 160, it becomes possible to heat the heat sinks 160 in entirety, and in turn it becomes possible to heat the display elements 106R, 106G, and 106B in a uniform manner. The element temperature sensors 162 are attached to the heat sinks 160 and are capable of measuring the temperature of the heat sinks 160, thereby enabling indirect detection of the temperature of the display elements 106R, 106G, and 106B. Meanwhile, each of the display elements 106R, 106G, and 106B includes a bandgap element temperature sensor (not illustrated) inside the element circuitry. Hence, the temperature of the display elements 106R, 106G, and 106B can be directly measured using the bandgap element temperature sensors.

On the backside of each of the first blue laser light source 101α, the second blue laser light source 101β, and the third blue laser light source 101γ; the display mechanism 10 includes a light source heater (light source heating unit) 171 disposed through a heat sink 170 and includes a light source temperature sensor 172 disposed on the heat sink 170. The heat sinks 170 are plate members made of a metal such as aluminum having high thermal conductivity and having a constant thickness. Each heat sink 170 is formed to be greater in size than the backside of the corresponding laser light source, and the entire backside of the light source remains in contact with the heat sink 170.

The light source heaters 171 heat the laser light sources 101α, 101β, and 101γ via the corresponding heat sinks 170. As the light source heaters 171, for example, plate-like ceramic heaters can be used. As a result of having the light source heaters 171 disposed in the heat sinks 170, it becomes possible to heat the heat sinks 170 in entirety, and in turn it becomes possible to heat the laser light sources 101α, 101β, and 101γ in a uniform manner. The light source temperature sensors 172 are attached to the heat sinks 170 and are capable of measuring the temperature of the heat sinks 170, thereby enabling indirect detection of the temperature of the laser light sources 101α, 101β, and 101γ. In the first embodiment, the display mechanism 10 includes the heat sink 170 and the light source heater 171 individually for each of the laser light sources 101α, 101β, and 101γ. However, alternatively, a common heat sink can be disposed for the laser light sources 101α, 101β, and 101γ, and a common light source heater can be disposed on that heat sink.

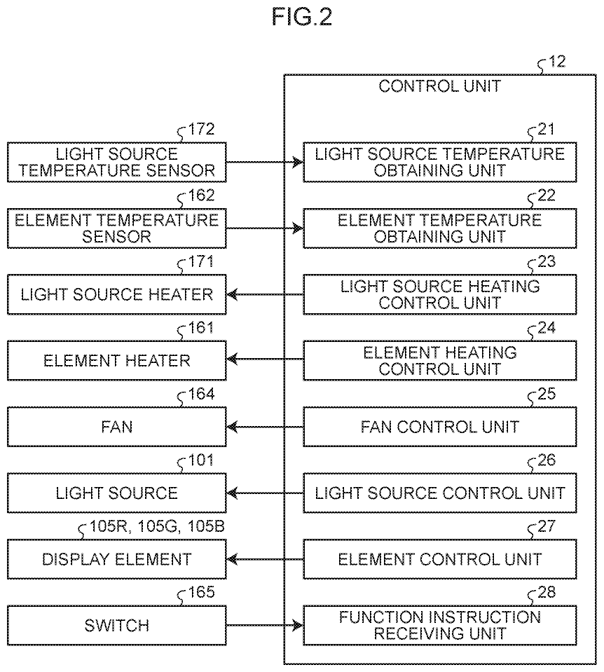

Given below is the explanation about the control unit 12. FIG. 2 is a schematic block diagram of the control unit according to the first embodiment. As illustrated in FIG. 2, the control unit 12 includes a light source temperature obtaining unit 21, an element temperature obtaining unit 22, a light source heating control unit 23, an element heating control unit 24, a fan control unit 25, a light source control unit 26, an element control unit 27, and a function instruction receiving unit 28. The light source heating control unit 23, the element heating control unit 24, the fan control unit 25, the light source control unit 26, and the element control unit 27 can be configured using an integrated circuit representing hardware; or the configuration can include a central processing unit (CPU), which represents an arithmetic device of a computer, and a memory, and the CPU can be made to execute a computer program (software) stored in the memory. In the first embodiment, the explanation is given only about the operation control of the abovementioned constituent elements in regard to implementation or deactivation of the hide function. Thus, the other explanation is not given.

The light source temperature obtaining unit 21 obtains the temperature data of the laser light sources 101α, 101β, and 101γ as detected by the corresponding light source temperature sensors 172. Then, the light source temperature obtaining unit 21 outputs the obtained temperature data of the laser light sources 101α, 101β, and 101γ to the light source heating control unit 23 and the fan control unit 25.

The element temperature obtaining unit 22 obtains the temperature data of the display elements 106R, 106G, and 106B as detected by the corresponding element temperature sensors 162. Then, the element temperature obtaining unit 22 outputs the obtained temperature data of the display elements 106R, 106G, and 106B to the element heating control unit 24 and the fan control unit 25.

Based on the temperature data of the laser light sources 101α, 101β, and 101γ as input from the light source temperature obtaining unit 21, the light source heating control unit 23 controls the operation of the light source heaters 171 disposed in the laser light sources 101α, 101β, and 101γ. More particularly, the light source heating control unit 23 sets, as a first light source temperature, the temperature data of the laser light sources 101α, 101β, and 101γ obtained immediately before the implementation of the hide function; and, with the aim of keeping the laser light sources 101α, 101β, and 101γ maintained at the first light source temperature, drives the light source heaters 171 and controls the operation of heating the laser light sources 101α, 101β, and 101γ. That is, for example, when the detected temperature of the first blue laser light source 101α is lower than the first light source temperature that is set, the light source heating control unit 23 switches on (operates) the corresponding light source heater 171 and performs control to heat the first blue laser light source 101α. As a result of performing such control, the light source heaters 171 perform heating so that, even during the implementation of the hide function (i.e., even when the light source 101 are stopped), the laser light sources 101α, 101β, and 101γ are uniformly heated to an appropriate temperature via the heat sinks 170. Moreover, when the temperature data input from the light source temperature obtaining unit 21 indicates that the temperature has reached a second light source temperature that is higher than the first light source temperature, the light source heating control unit 23 performs control to switch off (stop) the light source heaters 171. The second light source temperature is set to be higher than the first light source temperature by a predetermined temperature (for example, by 5° C. to 10° C.). In this configuration, once the laser light sources 101α, 101β, and 101γ are sufficiently heated to an appropriate temperature, the light source heaters 171 are switched off to avoid excessive heating.

Based on the temperature data of the display elements 106R, 106G, and 106B as input from the element temperature obtaining unit 22, the element heating control unit 24 controls the operation of the element heaters 161 disposed in the display elements 106R, 106G, and 106B. More particularly, the element heating control unit 24 sets, as a first element temperature, the temperature data of the display elements 106R, 106G, and 106B obtained immediately before the implementation of the hide function; and, with the aim of keeping the display elements 106R, 106G, and 106B maintained at the first element temperature, drives the element heaters 161 and controls the operation of heating the display elements 106R, 106G, and 106B. That is, for example, when the detected temperature of the first display element 106R is lower than the first element temperature that is set, the element heating control unit 24 switches on the corresponding element heater 161 and performs control to heat the first display element 106R. As a result of performing such control, the element heaters 161 perform heating so that, even during the implementation of the hide function (i.e., even when the display elements are stopped), the display elements 106R, 106G, and 106B are uniformly heated to an appropriate temperature via the heat sinks 160. Meanwhile, the target temperature for the display elements 106R, 106G, and 106B is set in advance. Hence, regardless of whether or not the hide function is implemented, the element heating control unit 24 can be configured to control the element heaters 161 for maintaining the target temperature at all times. When the temperature data input from the element temperature obtaining unit 22 indicates that the temperature has reached a second element temperature that is higher than the first element temperature, the element heating control unit 24 performs control to switch off the element heaters 161. The second element temperature is set to be higher than the first element temperature by a predetermined temperature (for example, by 1° C. to 2° C.). In this configuration, once the display elements 106R, 106G, and 106B are sufficiently heated to an appropriate temperature, the element heaters 161 are switched off to avoid excessive heating.

The fan control unit 25 controls the operation of a fan 164 based on the temperature data input from the light source temperature obtaining unit 21 or the element temperature obtaining unit 22. The fan 164 is disposed, for example, inside a housing (not illustrated) in which the display mechanism 10 is housed; and blows air onto the heat sinks 170 corresponding to the light sources and onto the heat sinks 160 corresponding to the display elements, so that the display mechanism 10 gets cooled (particularly the laser light sources 101α, 101β, and 101γ and the display elements 106R, 106G, and 106B get cooled). For example, when the temperature data input from the light source temperature obtaining unit 21 or the element temperature obtaining unit 22 indicates that the temperature has reached the higher temperature between the second light source temperature and the second element temperature, the fan control unit 25 performs control to operate the fan 164. As a result, the temperature of the laser light sources 101α101β, and 101γ as well as the temperature of the display elements 106R, 106G, and 106B can be prevented from rising excessively. Meanwhile, as an alternative configuration, a fan for cooling the laser light sources 101α, 101β, and 101γ and a fan for cooling the display elements 106R, 106G, and 106B can be disposed inside the housing (not illustrated). Thus, when the temperature data input from the light source temperature obtaining unit 21 indicates that the temperature has reached the second light source temperature or when the temperature data input from the element temperature obtaining unit 22 indicates that the temperature has reached the second element temperature, the corresponding fan is operated.

The function instruction receiving unit 28 receives an instruction regarding the hide function based on the operation of the switch 165. More particularly, the function instruction receiving unit 28 either receives an instruction for implementing the hide function or receives an instruction for deactivating the hide function. Then, the function instruction receiving unit 28 outputs the received instruction regarding the hide function to the light source control unit 26 and the element control unit 27.

The light source control unit 26 controls the operation of the light source 101 based on the instruction regarding the hide function as input from the function instruction receiving unit 28. More particularly, when an instruction for implementing the hide function is received from the function instruction receiving unit 28 based on the operation of the switch 165, the light source control unit 26 performs control to stop (switch off) the light emission from the light source 101 (the laser light sources 101α101β, and 101γ). Moreover, when an instruction for deactivating the hide function is received from the function instruction receiving unit 28 based on the operation of the switch 165, the light source control unit 26 performs control to start (switch on) the light emission from the light source 101 (the laser light sources 101α, 101β, and 101γ).

The element control unit 27 controls the operation of the display elements 106R, 106G, and 106B based on the instruction regarding the hide function as input from the function instruction receiving unit 28. More particularly, when an instruction for implementing the hide function is received from the function instruction receiving unit 28 based on the operation of the switch 165, the element control unit 27 performs control to stop the operation of the display elements 106R, 106G, and 106B or to display a completely black screen. Moreover, when an instruction for deactivating the hide function is received from the function instruction receiving unit 28 based on the operation of the switch 165, the element control unit 27 performs control to again operate the display elements 106R, 106G, and 106B.

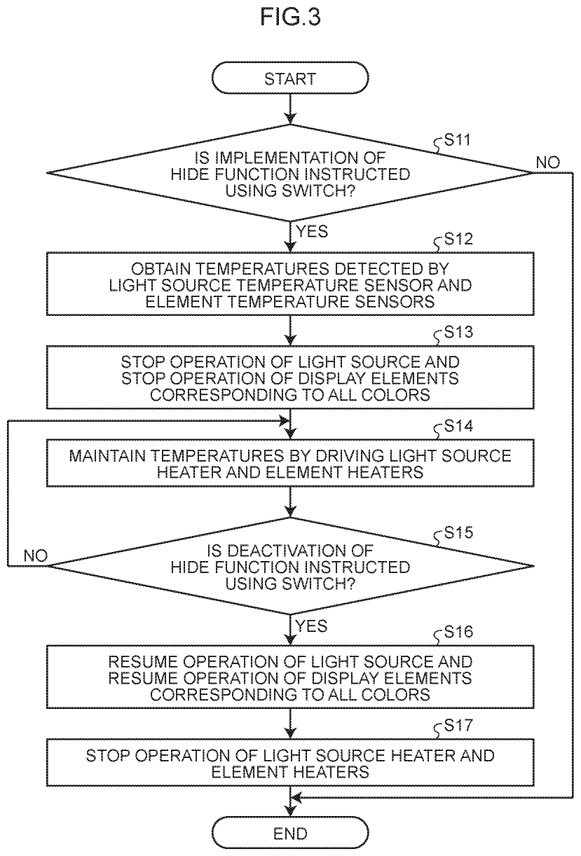

Given below is the explanation of the control operations performed by the constituent elements of the control unit. FIG. 3 is a flowchart for explaining the sequence of operations performed by the control unit according to the first embodiment. In the flowchart, it is assumed that the projection display device 100 is projecting images and that the hide mode is selected. As illustrated in FIG. 3, the control unit 12 determines whether or not implementation of the hide function is instructed via the switch 165 (Step S11). More specifically, the function instruction receiving unit 28 determines whether or not an instruction for implementing the hide function is received via the switch 165. When it is determined that the implementation of the hide function is not instructed via the switch 165 (No at Step S11), the control unit 12 ends the operations.

On the other hand, when it is determined that the implementation of the hide function is instructed via the switch 165 (Yes at Step S11), the control unit 12 obtains the temperature data detected by the light source temperature sensors 172 and the element temperature sensors 162 (Step S12). More specifically, in the control unit 12, immediately before the implementation of the hide function is instructed, the light source temperature obtaining unit 21 obtains the temperature data of the laser light sources 101α, 101β, and 101γ as detected by the light source temperature sensors 172, and the element temperature obtaining unit 22 obtains the temperature data of the display elements 106R, 106G, and 106B as detected by the element temperature sensor 162.

Then, the control unit 12 stops the operation of the laser light sources 101α, 101β, and 101γ and the display elements 106R, 106G, and 106B (Step S13). More specifically, in the control unit 12, when the function instruction receiving unit 28 receives an instruction for implementing the hide function, the light source control unit 26 stops (turns off) the light emission from the laser light sources 101α, 101β, and 101γ; and the element control unit 27 stops the operation of the display elements 106R, 106G, and 106B or displays a completely black screen. As a result, the hide function meant for temporarily hiding the projection of images gets implemented in the projection display device 100.

Then, the control unit 12 operates the light source heaters 171 for maintaining the temperature of the laser light sources 101α, 101β, and 101γ and operates the element heaters 161 for maintaining the temperature of the display elements 106R, 106G, and 106B (Step S14). More specifically, in the control unit 12, the temperature of the laser light sources 101α, 101β, and 101γ attained immediately before the implementation of the hide function is set as the first light source temperature; and, with the aim of keeping the laser light sources 101α, 101β, and 101γ maintained at the first light source temperature, the light source heating control unit 23 drives the light source heaters 171 and controls the operation of heating the laser light sources 101α, 101β, and 101γ. In that case, in the control unit 12, when the temperature of the laser light sources 101α, 101β, and 101γ reaches the second light source temperature that is higher than the first light source temperature, the light source heating control unit 23 performs control to switch off (stop) the light source heaters 171. As a result, it becomes possible to avoid excessive heating of the laser light sources 101α, 101β, and 101γ.

Moreover, in the control unit 12, the temperature of the display elements 106R, 106G, and 106B attained immediately before the implementation of the hide function is set as the first element temperature; and, with the aim of keeping the display elements 106R, 106G, and 106B maintained at the first element temperature, the element heating control unit 24 drives the element heaters 161 and controls the operation of heating the display elements 106R, 106G, and 106B. In that case, in the control unit 12, when the temperature of the display elements 106R, 106G, and 106B reaches the second element temperature that is higher than the first element temperature, the element heating control unit 24 performs control to switch off (stop) the element heaters 161. As a result, it becomes possible to avoid excessive heating of the display elements 106R, 106G, and 106B.

When the temperature of the laser light sources 101α101β, and 101γ and the temperature of the display elements 106R, 106G, and 106B reaches the higher temperature between the second light source temperature and the second element temperature, the control unit 12 performs control to operate the fan 164. As a result, the laser light sources 101α101β, and 101γ and the display elements 106R, 106G, and 106B are cooled and are prevented from getting excessively heated.

Then, the control unit 12 determines whether or not an instruction for deactivating the hide function is given using the switch 165 (Step S15). More specifically, in the control unit 12, the function instruction receiving unit 28 determines whether or not an instruction for deactivating the hide function is received via the switch 165. When it is determined that an instruction for deactivating the hide function is given using the switch 165 (No at Step S15), the system control returns to Step S14.

On the other hand, when it is determined that an instruction for deactivating the hide function is given using the switch 165 (Yes at Step S15), the control unit 12 resumes the operation of the laser light sources 101α, 101β, and 101γ and the display elements 106R, 106G, and 106B (Step S16). More specifically, in the control unit 12, when the function instruction receiving unit 28 receives an instruction for deactivating the hide function via the switch 165, the light source control unit 26 resumes the operation of switching on (start the light emission from) the laser light sources 101α, 101β, and 101γ. Moreover, in the control unit 12, the element control unit 27 resumes the operation of switching on the display elements 106R, 106G, and 106B. As a result, in the projection display device 100, the hide function meant for temporarily hiding the projection of images gets deactivated, and the projection of images is resumed. At that time, the temperature of the laser light sources 101α, 101β, and 101γ is maintained at the first light source temperature by the light source heaters 171, and the temperature of the display elements 106R, 106G, and 106B is maintained at the first element temperature by the element heaters 161. For that reason, when the hide function is deactivated, the output of the laser light sources 101α, 101β, and 101γ can be stabilized, and the color tone produced by the display elements 106R, 106G, and 106B can be stabilized. As a result, excellent images can be projected in a prompt manner.

Subsequently, the control unit 12 stops the operation of the light source heaters 171 and the element heaters 161 (Step S17). More specifically, due to the resumption of the operation of the laser light sources 101α, 101β, and 101γ and the display elements 106R, 106G, and 106B, there is no need for further heating. Hence, the light source heating control unit 23 stops the operation of the light source heaters 171, and the element heating control unit 24 stops the operation of the element heaters 161. That marks the end of the sequence of operations.

As explained above, the projection display device 100 according to the first embodiment includes the laser light sources 101α, 101β, and 101γ that emit laser lights to be used in the projection of images; and is equipped with the hide function meant for temporarily hiding the projection of images by stopping the light emission from the laser light sources 101α101β, and 101γ. Moreover, the projection display device 100 includes: the light source temperature sensors 172 that detect the temperature of the laser light sources 101α, 101β, and 101γ; the light source heaters 171 that heat the laser light sources 101α, 101β, and 101γ; the control unit 12 that controls the operation of at least the laser light sources 101α, 101β, and 101γ and the light source heaters 171; and the switch 165 that is used to instruct implementation or deactivation of the hide function. When implementation of the hide function is instructed using the switch 165, the control unit 12 stops the light emission from the laser light sources 101α, 101β, and 101γ; obtains the temperature detected by the light source temperature sensors 172; and controls the light source heaters 171 to ensure that the laser light sources 101α, 101β, and 101γ are maintained at the obtained temperature. According to such a configuration, when the hide function is deactivated, since the temperature of the laser light sources 101α, 101β, and 101γ is maintained, the output of the laser light sources 101α, 101β, and 101γ can be stabilized. As a result, excellent images can be projected in a prompt manner.

In the projection display device 100 according to the first embodiment, When deactivation of the hide function is instructed using the switch 165, the control unit 12 starts the light emission from the laser light sources 101α, 101β, and 101γ, and stops the heating operation of the light source heaters 171. According to such a configuration, as a result of starting the light emission from the laser light sources 101α, 101β, and 101γ, the temperature of the laser light sources 101α, 101β, and 101γ can be maintained even without the heating performed by the light source heaters 171. As a result, excellent images can be projected in a prompt manner.

The projection display device 100 according to the first embodiment includes: the display elements 106R, 106G, and 106B that are disposed corresponding to the red color, the green color, and the blue color, respectively, and that apply laser lights to generate image lights corresponding to those colors; the element heaters 161 that heat the display elements 106R, 106G, and 106B; and the element temperature sensors 162 that detect the temperature of the display elements 106R, 106G, and 106B. When implementation of the hide function is instructed using the switch 165, the control unit 12 stops the operation of the display elements 106R, 106G, and 106B; obtains the temperature detected by the element temperature sensors 162; and controls the element heaters 161 to ensure that the display elements 106R, 106G, and 106B are maintained at the obtained temperature. When deactivation of the hide function is instructed using the switch 165, the control unit 12 starts the operation of the display elements 106R, 106G, and 106B, and stops the heating operation of the element heaters 161. According to such a configuration, when the hide function is deactivated, since the temperature of the display elements 106R, 106G, and 106B is maintained, the color tone produced by the display elements 106R, 106G, and 106B can be stabilized. As a result, excellent images can be projected in a prompt manner.

### Second Embodiment

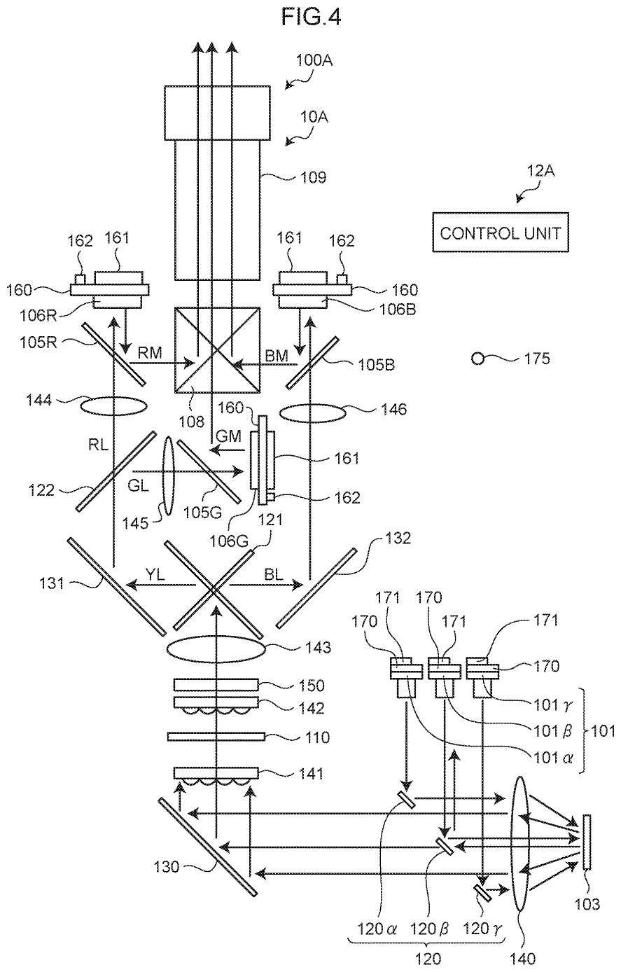

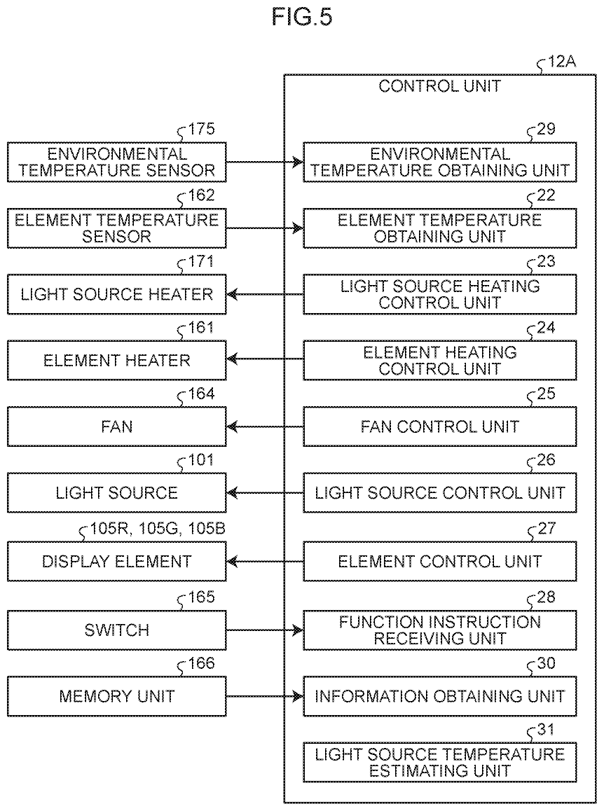

Given below is the description of a second embodiment. FIG. 4 is a schematic diagram illustrating a projection display device according to the second embodiment. FIG. 5 is a schematic block diagram of a control unit according to the second embodiment. In a projection display device 100A according to the second embodiment, the identical constituent elements to the first embodiment are referred to by the same reference numerals and their explanation is not given again. As illustrated in FIG. 4, the projection display device 100A includes a display mechanism 10A and a control unit 12A. In the second embodiment, as illustrated in FIG. 4, on the backside of each of the first blue laser light source 101α, the second blue laser light source 101β, and the third blue laser light source 101γ; the display mechanism 10 includes the light source heater (light source heating unit) 171 disposed through the heat sink 170. However, unlike the first embodiment, light source temperature sensors are not disposed. Instead, the display mechanism 10A includes an environmental temperature sensor 175 that detects the environmental temperature inside the display mechanism 10A. The environmental temperature sensor 175 is disposed, for example, inside the housing (not illustrated) in which the display mechanism 10A is housed; and detects the environmental temperature inside the housing.

As illustrated in FIG. 5, the control unit 12A includes the element temperature obtaining unit 22, the light source heating control unit 23, the element heating control unit 24, the fan control unit 25, the light source control unit 26, the element control unit 27, the function instruction receiving unit 28, an environmental temperature obtaining unit 29, an information obtaining unit 30, and a light source temperature estimating unit 31. The light source heating control unit 23, the element heating control unit 24, the fan control unit 25, the light source control unit 26, the element control unit 27, and the light source temperature estimating unit 31 can be configured using an integrated circuit representing hardware; or the configuration can include a central processing unit (CPU), which represents an arithmetic device of a computer, and a memory, and the CPU can be made to execute a computer program (software) stored in the memory. In the second embodiment, the explanation is given only about the operation control of the abovementioned constituent elements in regard to implementation or deactivation of the hide function. Thus, no other explanation is given. Moreover, the identical constituent elements to the first embodiment are referred to by the same reference numerals, and their explanation is not given again.

As explained above, the light source control unit 26 controls the operation of the laser light sources 101α101β, and 101γ based on the instruction related to the hide function as input from the function instruction receiving unit 28. When an instruction for implementing the hide function is received from the function instruction receiving unit 28 based on the operation of the switch 165, the light source control unit 26 stops the light emission from the laser light sources 101α, 101β, and 101γ. At that time, the light source control unit 26 reads the output value of the laser light sources 101α, 101β, and 101γ indicated immediately before the implementation of the hide function, and outputs the output value to the light source temperature estimating unit 31.

The environmental temperature obtaining unit 29 obtains the temperature data of the environmental temperature (the air temperature) inside the housing of the display mechanism 10A as detected by the environmental temperature sensor 175. The environmental temperature obtaining unit 29 outputs the obtained temperature data to the light source temperature estimating unit 31.

The information obtaining unit 30 obtains, from a memory unit 166, the information regarding the relationship between the output value (the output) and the temperature of the laser light sources 101α, 101β, and 101γ, and the information regarding the relationship between the output value (the output) of the light source heaters 171 and the temperature of the laser light sources 101α, 101β, and 101γ. More particularly, by performing an experiment in advance, the information related to the temperature of the laser light sources 101α, 101β, and 101γ at the time when they are made to emit light at a predetermined output value is stored in the memory unit 166. In that case, when the environmental temperature and the output value are varied, the information related to the temperatures of the laser light sources 101α, 101β, and 101γ corresponding to the variations in the environmental temperature and the output value is stored (for example, as table data) in the memory unit 166. Hence, at a predetermined environmental temperature, when the laser light sources 101α, 101β, and 101γ are made to emit light at a predetermined output value, the information obtaining unit 30 can obtain the information related to the temperature of the laser light sources 101α101β, and 101γ corresponding to that environmental temperature and that output value.

Moreover, by performing an experiment in advance, in the state in which the laser light sources 101α, 101β, and 101γ are switched off, the information related to the temperature of the laser light sources 101α, 101β, and 101γ at the time when the light source heaters 171 are operated at a predetermined output value is stored in the memory unit 166. In that case, when the environmental temperature and the output value of the light source heaters 171 are varied, the information related to the temperatures of the laser light sources 101α, 101β, and 101γ corresponding to the variations in the environmental temperature and the output value is stored (for example, as table data) in the memory unit 166. For that reason, at a predetermined environmental temperature, when the light source heaters 171 are operated at a predetermined output value, the information obtaining unit 30 can obtain the information related to the temperature of the laser light sources 101α, 101β, and 101γ (i.e., the temperature rising due to heating) corresponding to that environmental temperature and that output value. Then, the information obtaining unit 30 outputs the obtained information to the light source temperature estimating unit 31.

Based on the information obtained by the information obtaining unit 30, the light source temperature estimating unit 31 estimates the temperature of the laser light sources 101α, 101β, and 101γ corresponding to their output value. More particularly, from the output value of the laser light sources 101α, 101β, and 101γ indicated immediately before the implementation of the hide function as input from the light source control unit 26, and from the environmental temperature; the light source temperature estimating unit 31 reads the information related to the temperature of the laser light sources 101α, 101β, and 101γ corresponding to the output value and the environmental temperature; and estimates that temperature to be the temperature attained by the laser light sources 101α, 101β, and 101γ immediately before the implementation of the hide function.

Based on the information obtained by the information obtaining unit 30, the light source heating control unit 23 controls the light source heaters 171 to perform output at the output value corresponding to the estimated temperature of the laser light sources 101α, 101β, and 101γ. As a result of being heated by the light source heaters 171, even after the hide function is implemented, the laser light sources 101α, 101β, and 101γ are maintained at the temperature attained immediately before the implementation of the hide function.

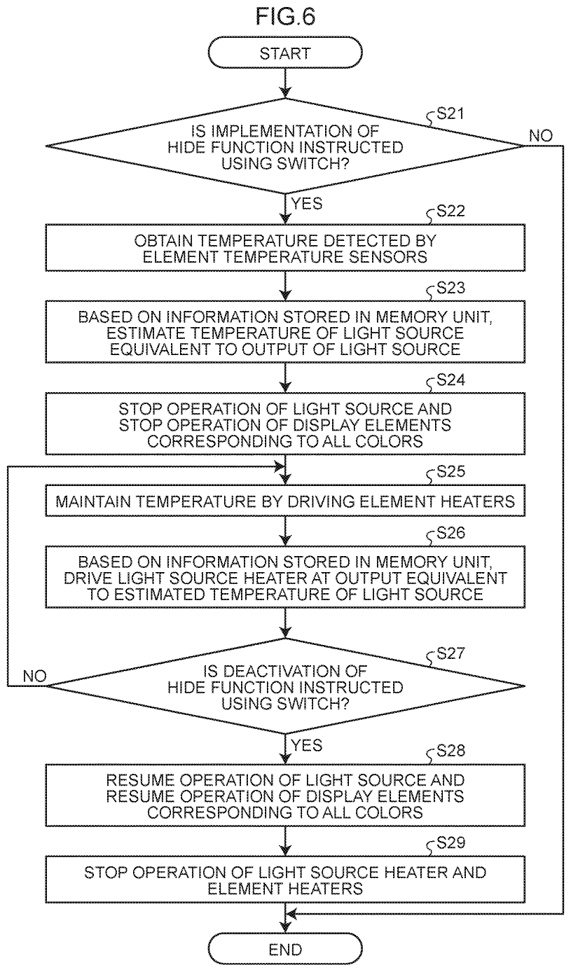

Given below is the explanation of the control operations performed by the constituent elements of the control unit 12A. FIG. 6 is a flowchart for explaining the sequence of operations performed by the control unit according to the second embodiment. In this flowchart too, it is assumed that the projection display device 100 is projecting images and that the hide mode is selected. As illustrated in FIG. 6, the control unit 12A determines whether or not implementation of the hide function is instructed via the switch 165 (Step S21). More specifically, the function instruction receiving unit 28 determines whether or not an instruction for implementing the hide function is received via the switch 165. When it is determined that the implementation of the hide function is not instructed via the switch 165 (No at Step S21), the control unit 12A ends the operations.

On the other hand, when it is determined that the implementation of the hide function is instructed via the switch 165 (Yes at Step S21), the control unit 12A obtains the temperature data detected by the element temperature sensors 162 (Step S22). More specifically, in the control unit 12A, the element temperature obtaining unit 22 obtains the temperature data of the display elements 106R, 106G, and 106B as detected by the element temperature sensors 162 immediately before the implementation of the hide function is instructed.

Then, in the control unit 12A, the temperature of the light sources equivalent to the output value of the light sources is estimated based on the information stored in the memory unit 166 (Step S23). More specifically, in the control unit 12A, the information obtaining unit 30 obtains, from the memory unit 166, the information regarding the relationship between the output value (the output) and the temperature of the laser light sources 101α, 101β, and 101γ, and the information regarding the relationship between the output value (the output) of the light source heaters 171 and the temperature of the laser light sources 101α, 101β, and 101γ. Subsequently, in the control unit 12A, based on the information obtained by the information obtaining unit 30, the light source temperature estimating unit 31 estimates the temperature of the laser light sources 101α101β, and 101γ corresponding to (equivalent to) their output value. More particularly, from the output value of the laser light sources 101α, 101β, and 101γ indicated immediately before the implementation of the hide function as input from the light source control unit 26, and from the environmental temperature; the light source temperature estimating unit 31 reads the information related to the temperature of the laser light sources 101α, 101β, and 101γ that corresponds to the output value and the environmental temperature; and estimates that temperature to be the temperature attained by the laser light sources 101α, 101β, and 101γ immediately before the implementation of the hide function.

Subsequently, the control unit 12A stops the operation of the laser light sources 101α, 101β, and 101γ and the display elements 106R, 106G, and 106B (Step S24). More specifically, in the control unit 12, when the function instruction receiving unit 28 receives an instruction for implementing the hide function, the light source control unit 26 stops (switches off) the light emission from the laser light sources 101α, 101β, and 101γ; and the element control unit 27 stops the operation of the display elements 106R, 106G, and 106B or displays a completely black screen. As a result, the hide function meant for temporarily hiding the projection of images gets implemented in the projection display device 100.

Subsequently, the control unit 12A operates the element heaters 161 for maintaining the temperature of the display elements 106R, 106G, and 106B (Step S25). More specifically, in the control unit 12A, the element heating control unit 24 sets, as the first element temperature, the temperature of the display elements 106R, 106G, and 106B attained immediately before the implementation of the hide function; and, with the aim of keeping the display elements 106R, 106G, and 106B maintained at the first element temperature, drives the element heaters 161 and controls the operation of heating the display elements 106R, 106G, and 106B. In that case, in the control unit 12, when the temperature of the display elements 106R, 106G, and 106B reaches the second element temperature that is higher than the first element temperature, the element heating control unit 24 performs control to switch off (stop) the element heaters 161. As a result, it becomes possible to avoid excessive heating of the display elements 106R, 106G, and 106B.

Then, based on the information stored in the memory unit 166, the control unit 12A drives the light heaters at the output equivalent to the estimated temperature of the light sources (Step S26). As explained earlier, in the control unit 12A, the information obtaining unit 30 obtains, from the memory unit 166, the information regarding the relationship between the output value and the temperature of the laser light sources 101α, 101β, and 101γ, and the information regarding the relationship between the output value (the output) of the light source heaters 171 and the temperature of the laser light sources 101α, 101β, and 101γ. Then, based on the information obtained by the information obtaining unit 30, the control unit 12A controls the light source heaters 171 to perform output at the output value corresponding to the estimated temperature of the laser light sources 101α, 101β, and 101γ. As a result of being heated by the light source heaters 171, even after the hide function is implemented, the laser light sources 101α, 101β, and 101γ are maintained at the temperature attained immediately before the implementation of the hide function.

Then, the control unit 12A determines whether or not deactivation of the hide function is instructed using the switch 165 (Step S27). More specifically, in the control unit 12A, the function instruction receiving unit 28 determines whether or not an instruction for deactivating the hide function is received via the switch 165. When it is determined that the deactivation of the hide function is not instructed using the switch 165 (No at Step S27), the system control returns to Step S25.

On the other hand, when it is determined that the deactivation of the hide function is instructed using the switch 165 (Yes at Step S27), the control unit 12A resumes the operation of the laser light sources 101α, 101β, and 101γ and the display elements 106R, 106G, and 106B (Step S28). More specifically, in the control unit 12A, when the function instruction receiving unit 28 receives an instruction for deactivating the hide function, the light source control unit 26 resumes the operation of switching on (start the light emission from) the laser light sources 101α, 101β, and 101γ. Moreover, in the control unit 12A, the element control unit 27 resumes the operation of switching on the display elements 106R, 106G, and 106B. As a result, in the projection display device 100A, the hide function meant for temporarily hiding the projection of images gets deactivated, and the projection of images is resumed. At that time, the temperature of the laser light sources 101α, 101β, and 101γ and the temperature of the display elements 106R, 106G, and 106B are maintained by the light source heaters 171 and the element heaters 161, respectively, to a temperature attained immediately before the implementation of the hide function (for example, to the first element temperature). For that reason, when the hide function is deactivated, the output of the laser light sources 101α, 101β, and 101γ can be stabilized, and the color tone produced by the display elements 106R, 106G, and 106B can be stabilized. As a result, excellent images can be projected in a prompt manner.

Subsequently, the control unit 12 stops the operation of the light source heaters 171 and the element heaters 161 (Step S29). More specifically, due to the resumption of the operation of the laser light sources 101α, 101β, and 101γ and the display elements 106R, 106G, and 106B, there is no need for further heating. Hence, the light source heating control unit 23 stops the operation of the light source heaters 171, and the element heating control unit 24 stops the operation of the element heaters 161. That marks the end of the sequence of operations.

The projection display device 100A according to the second embodiment includes the laser light sources 101α101β, and 101γ that emit laser lights to be used in the projection of images; and is equipped with the hide function meant for temporarily hiding the projection of images by stopping the light emission from the laser light sources 101α, 101β, and 101γ. The projection display device 100A includes: the light source heaters 171 that heat the laser light sources 101α, 101β, and 101γ; the information obtaining unit 30 that obtains the information regarding the relationship between the output value and the temperature of the laser light sources 101α, 101β, and 101γ, and the information regarding the relationship between the output value of the light source heaters 171 and the temperature of the laser light sources 101α, 101β, and 101γ; the control unit 12A that controls the operation of at least the laser light sources 101α, 101β, and 101γ and the light source heaters 171; and the switch 165 that is used to instruct implementation or deactivation of the hide function. When implementation of the hide function is instructed using the switch 165, the control unit 12 stops the light emission from the laser light sources 101α, 101β, and 101γ; estimates, based on the information obtained by the information obtaining unit 30, the temperature of the laser light sources 101α, 101β, and 101γ corresponding to the output value thereof; and controls the light source heaters 171 to perform at the output value corresponding to the estimated temperature. With such a configuration, using the light source heaters 171, the laser light sources 101α101β, and 101γ can be maintained at the temperature attained immediately before the implementation of the hide function. Hence, when the hide function is deactivated, the output of the laser light sources 101α, 101β, and 101γ can be stabilized, thereby enabling prompt projection of excellent images.

According to the embodiments, the light source heating unit is operated to maintain the temperature of the light source to the temperature attained when the hide function is implemented. Hence, when the hide function is deactivated, excellent images can be projected in a prompt manner.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A projection display device in which a light source emits a laser light to be used in projection of an image and in which a hide function is provided that temporarily hides projection of the image by stopping emission of light from the light source, the projection display device comprising:
a light source temperature sensor that detects temperature of the light source;
a light source heating unit that heats the light source;
a control unit that controls operation of at least the light source and the light source heating unit; and
a switch that is used to instruct implementation or deactivation of the hide function, wherein
when implementation of the hide function is instructed using the switch, the control unit stops emission of light from the light source, obtains temperature detected by the light source temperature sensor, and controls the light source heating unit to maintain the light source at the obtained temperature.

2. The projection display device according to claim 1, wherein, when deactivation of the hide function is instructed using the switch, the control unit starts emission of light from the light source and stops heating operation performed by the light source heating unit.

3. The projection display device according to claim 1, further comprising:
liquid crystal display elements that are disposed corresponding to red color, green color, and blue color and that apply laser lights to generate image lights corresponding to colors;
an element heating unit that heats the liquid crystal display elements; and
an element temperature sensor that detects temperature of the liquid crystal display elements, wherein
when implementation of the hide function is instructed using the switch, the control unit stops operation of the liquid crystal display elements or displays a completely black screen, obtains temperature detected by the element temperature sensor, and controls the element heating unit to maintain the liquid crystal display elements at the obtained temperature, and
when deactivation of the hide function is instructed using the switch, the control unit starts operation of the liquid crystal display elements and stops heating operation of the element heating unit.

4. A projection display device in which a light source emits a laser light to be used in projection of an image and in which a hide function is provided that temporarily hides projection of the image by stopping emission of light from the light source, the projection display device comprising:
a light source heating unit that heats the light source;
an information obtaining unit that obtains relationship between output of the light source and temperature of the light source, and obtains relationship between output of the light source heating unit and temperature of the light source;
a control unit that controls operation of at least the light source and the light source heating unit; and
a switch that is used to instruct implementation or deactivation of the hide function, wherein
when implementation of the hide function is instructed using the switch, the control unit stops emission of light from the light source; estimates, based on the information obtained by the information obtaining unit, temperature of the light source corresponding to output of the light source; and controls the light source heating unit to perform at output corresponding to the estimated temperature.

5. The projection display device according to claim 4, wherein, when deactivation of the hide function is instructed using the switch, the control unit starts emission of light from the light source and stops heating operation performed by the light source heating unit.

6. The projection display device according to claim 4, further comprising:
liquid crystal display elements that are disposed corresponding to red color, green color, and blue color and that apply laser lights to generate image lights corresponding to colors;
an element heating unit that heats the liquid crystal display elements; and
an element temperature sensor that detects temperature of the liquid crystal display elements, wherein
when implementation of the hide function is instructed using the switch, the control unit stops operation of the liquid crystal display elements or displays a completely black screen, obtains temperature detected by the element temperature sensor, and controls the element heating unit to maintain the liquid crystal display elements at the obtained temperature, and
when deactivation of the hide function is instructed using the switch, the control unit starts operation of the liquid crystal display elements and stops heating operation of the element heating unit.
